(19) United States
(12) Patent Application Publication
(10) Pub. No.: US 2025/0046902 A1
(43) Pub. Date: Feb. 6, 2025

(54) METHOD FOR RECOVERING LITHIUM IN PREPARATION FOR RECYCLING OF LITHIUM-ION BATTERIES

(71) Applicant: EnBW Energie Baden-Württemberg AG, Karlsruhe (DE)

(72) Inventors: Laura HERRMANN, Karlsruhe (DE); Thomas KÖLBEL, Karslruhe (DE); Elif KAYMAKCI, Waldbronn (DE); Magdalena GRACZYK-ZAJAC, Heidelberg (DE)

(21) Appl. No.: 18/789,970

(22) Filed: Jul. 31, 2024

(30) Foreign Application Priority Data
Aug. 3, 2023 (DE) 10 2023 120 697.4

(51) Int. Cl. H01M 10/54; B01D 15/12; B01D 15/16; B01D 15/20; B01J 20/06; B01J 20/08; B01J 20/34; C22B 1/24; C22B 3/24; C22B 3/42; C22B 7/00; C22B 26/12

(52) U.S. Cl. CPC H01M 10/54; B01D 15/125; B01D 15/161; B01D 15/203; B01J 20/06; B01J 20/08; B01J 20/3433; B01J 20/3475; C22B 1/24; C22B 3/24; C22B 3/42; C22B 7/006; C22B 26/12

(57) ABSTRACT

The invention relates to a method for recovering lithium during the preparation of the recycling of lithium-ion batteries, comprising: carrying out a shredding process, wherein at least one lithium-ion battery is mechanically shredded into fragments in the presence of a protective fluid that is in contact with the lithium-ion battery, following the shredding process, passing the protective fluid through a sorbent, wherein lithium ions contained in the protective fluid are bound by the sorbent, and a sorbent enriched with lithium ions is obtained, and passing a desorption fluid through the sorbent enriched with lithium ions, wherein lithium ions are desorbed from the sorbent by the desorption fluid, and a desorption fluid enriched with lithium ions is obtained.

### CROSS-REFERENCE TO RELATED APPLICATIONS

This application claims the benefit of and priority to German Patent Application No. 10 2023 120 697.4, filed on Aug. 3, 2023. The entire disclosure of the application identified in this paragraph is incorporated herein by reference.

### FIELD

The present invention relates to a method for recovering lithium during the preparation of the recycling of lithium-ion batteries.

### BACKGROUND

Due to its advantages, such as high electrical energy density, high electrical working voltage, long cyclic service life, lack of memory effect, etc., the rechargeable lithium-ion battery or lithium-ion accumulator is now widely used in electrical devices, such as laptops, mobile phones and electric cars. The demand for lithium is increasing sharply, partly due to the expansion of electromobility.

Given the increasing distribution of lithium-ion batteries, the amount of existing waste batteries is also increasing. In order to sustainably meet the demand for lithium, the recovery or recycling of waste batteries is of great importance. To prepare lithium-ion batteries for recycling, the lithium-ion batteries are typically first mechanically shredded into smaller fragments in a shredding process. If the lithium-ion batteries are charged or partially charged, there is a risk of fire during mechanical shredding. The shredding therefore often takes place in the presence of a protective fluid that fulfills a fire protection function. By mechanically shredding into fragments, the lithium-containing interior of the lithium-ion batteries is exposed. The lithium contained in the fragments can then be recovered during actual recycling by pyrometallurgical treatment and/or hydrometallurgical treatment of the fragments.

The object of the invention is to increase the efficiency with regard to the recovery of lithium from lithium-ion batteries.

This above object is achieved by a method according to the invention having the features of claim 1. The dependent claims and the description indicate advantageous variants and embodiments.

### SUMMARY

According to the invention, a method is provided for recovering lithium during the preparation of the recycling of lithium-ion batteries.

The method according to the invention comprises: carrying out a shredding process, wherein at least one lithium-ion battery is mechanically shredded into fragments in the presence of a protective fluid that is in contact with the lithium-ion battery.

At least one lithium-ion battery is brought into contact with a protective fluid and then mechanically shredded. The shredding process can be designed in different variants. For example, during the shredding process, shredding by cutting and/or shredding by crushing the at least one lithium-ion battery takes place. Preferably, the at least one lithium-ion battery is mechanically broken down into fragments by a shredder or chopper. The shredding process takes place in the presence of the protective fluid which is in contact with the at least one lithium-ion battery. Preferably, water or an aqueous solution is used as the protective fluid. Water or aqueous solutions are particularly suitable as the protective fluid because they reliably prevent temperature peaks and reduce the electrical charge when they come into contact with electrically charged lithium-ion batteries or electrically charged fragments of lithium-ion batteries. However, the presence of the protective fluid also results in a part of the substances of the at least one lithium-ion battery being released into the protective fluid. The released substances include lithium ions and other substances, such as phosphorus, nickel, cobalt, manganese, alcohols (methanol, ethanol), fluoride, sulfate, organic carbonates or inorganic carbonates. The protective fluid is therefore enriched with lithium ions. The other substances are summarized below under the term “foreign substances”.

The method according to the invention also comprises: after the shredding process, passing the protective fluid through a sorbent, wherein lithium ions contained in the protective fluid are bound by the sorbent, and a sorbent enriched with lithium ions is obtained, and passing a desorption fluid through the sorbent enriched with lithium ions, wherein lithium ions are desorbed from the sorbent by the desorption fluid, and a desorption fluid enriched with lithium ions is obtained.

In known methods, the protective fluid and thus the lithium ions contained in the protective fluid have been discarded after the shredding process. In contrast, by using the procedure according to the invention, i.e., passing the protective fluid through the sorbent and the associated extraction of lithium ions from the protective fluid, the overall efficiency with regard to the recovery of lithium from lithium-ion batteries can be increased. Surprisingly, it has been shown that the foreign substances contained in the protective fluid at most slightly impair the recovery of lithium by the sorbent. In particular, the expected damage to the chemically and mechanically unstable sorbent by the foreign substances turned out to be surprisingly low.

Preferably, the at least one lithium-ion battery is mechanically shredded in a bath of protective fluid during the shredding process. In this way, the protective fluid very effectively reduces the risk of fire. Because the lithium ions released into the protective fluid are recovered by the sorbent, a large volume of protective fluid can be used without adversely affecting the efficiency of recovering lithium from the at least one lithium-ion battery. Alternatively, the at least one lithium-ion battery can also simply be wetted with the protective fluid and then mechanically shredded.

The ultimately obtained desorption fluid enriched with lithium ions can be processed in further steps to ultimately obtain a battery-quality lithium compound.

The method can be used for different types of lithium-ion batteries, i.e., for different cell chemistry types. For example, the at least one lithium-ion battery is a nickel-manganese-cobalt accumulator or a lithium iron phosphate accumulator.

In some preferred embodiments, it is provided that the sorbent is an aluminum oxide-based sorbent. Aluminum oxide-based sorbents are chemically and mechanically very stable so that damage caused by foreign substances occurs at best to an extremely small extent. Aluminum oxide-based sorbents bind lithium ions by adsorption. During an adsorption process, the adsorbed material accumulates on a boundary surface of the sorbent and/or is incorporated into a layer structure of the sorbent. The aluminum oxide-based sorbent is particularly preferably an aluminum layered double hydroxide (LDH) with the chemical formula LiₓAl₂(OH)₆Clₓ·n H₂O, e.g., LiCl·Al₂(OH)₆·n H₂O. If the sorbent is an aluminum oxide-based sorbent, low-salt water is preferably used as the desorption fluid.

In some preferred embodiments, the sorbent is a manganese oxide-based sorbent. Manganese oxide-based sorbents are characterized by their high selectivity with regard to the binding of lithium ions so that fine purification can be achieved using manganese oxide-based sorbents. Manganese oxide-based sorbents bind lithium ions by exchanging bound hydrogen ions for lithium ions. Manganese oxide-based sorbents thus act as cation exchangers when binding lithium ions. Particularly preferably, the manganese oxide-based sorbent is a sorbent having the chemical formula HₓMn_{y}O_{z}, e.g., H_{1.6}Mn_{1.6}O₄. If the sorbent is a manganese oxide-based sorbent, an acidic desorption fluid is preferably used as the desorption fluid. The acidic desorption fluid particularly preferably comprises hydrochloric acid, sulfuric acid and/or acetic acid.

In some preferred embodiments, it is provided that the sorbent is a titanium oxide-based sorbent. Titanium oxide-based sorbents are also characterized by their high selectivity with regard to the binding of lithium ions. Titanium oxide-based sorbents also bind lithium ions by exchanging bound hydrogen ions for lithium ions. Particularly preferably, the titanium oxide-based sorbent is a sorbent having the chemical formula HₓTi_{y}O_{z}, e.g., H₂TiO₃. Preferably, an acidic desorption fluid is also used when using a titanium oxide-based sorbent. The acidic desorption fluid particularly preferably comprises hydrochloric acid, sulfuric acid and/or acetic acid.

A mixture of the above-mentioned sorbents can also be used as the sorbent, for example a mixture of a titanium oxide-based sorbent and a manganese oxide-based sorbent.

In some preferred embodiments, it is provided that the fragments of the at least one lithium-ion battery and the protective fluid are separated from one another before the protective fluid is passed through the sorbent. This prevents the sorbent from coming into contact with the fragments of the at least one lithium-ion battery. Particularly preferably, the fragments and the protective fluid are separated from each other by filtering. However, the fragments and the protective fluid can also be separated from each other, for example, by decanting.

In some preferred embodiments, it is provided that the protective fluid is passed through the sorbent without chemical pretreatment following the shredding process. Thus, between the completion of the shredding process and the subsequent introduction of the protective fluid into the sorbent, no chemical pretreatment of the protective fluid takes place. Chemical pretreatment means influencing a property of the protective fluid by adding one or more chemicals. Examples of such chemical pretreatment are the precipitation of a component of the protective fluid by adding a suitable precipitating agent or the change of the pH value of the protective fluid by adding an acid or a base. By dispensing with chemical pretreatment, the method can be carried out in a particularly time-efficient manner.

In some preferred embodiments, it is provided that a temperature of the protective fluid exceeds a threshold temperature of 40° C. when the protective fluid is introduced into the sorbent. It has been shown that at such a temperature of the protective fluid, lithium ions are particularly effectively bound by the sorbent. Preferably, the temperature of the protective fluid when introducing the protective fluid into the sorbent exceeds a threshold temperature of 50° C., preferably a threshold temperature of 70° C., particularly preferably a threshold temperature of 80° C.

In some preferred embodiments, it is provided that the shredding process is carried out in such a way that the protective fluid is heated by the shredding process to a temperature exceeding the threshold temperature. The heating of the protective fluid during the shredding process is mainly caused by the discharge of charged or partially charged lithium-ion batteries or fragments of lithium-ion batteries. A desired temperature of the protective fluid can be adjusted, for example, by changing the ratio of protective fluid to lithium-ion batteries or by changing the average charge state of the lithium-ion batteries to be shredded. The heating of the protective fluid through the shredding process has the advantage that energy-intensive separate heating of the protective fluid can be omitted. Instead, the heat energy that is released anyway is used to heat the protective fluid.

In some preferred embodiments, it is provided that lithium contained in the fragments is recovered by a pyrometallurgical treatment and/or by a hydrometallurgical treatment of the fragments. The fragments of the at least one lithium-ion battery produced in the shredding process are thus further processed by a pyrometallurgical treatment and/or a hydrometallurgical treatment. This processing of the fragments constitutes the actual recycling of the at least one lithium-ion battery.

### BRIEF DESCRIPTION OF DRAWINGS

The invention is described in more detail below with reference to the figures, the same or functionally equivalent elements possibly being provided with reference signs only once. The description serves as an example and is not to be understood as limiting. In the figures:

FIG. 1 shows a schematic representation of a system for preparing the recycling of lithium-ion batteries; and

FIG. 2 shows a method for recovering lithium during the preparation of the recycling of lithium-ion batteries.

### DETAILED DESCRIPTION

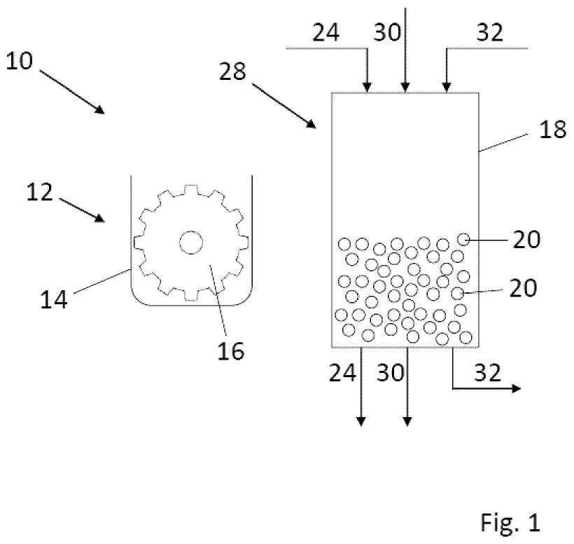

FIG. 1 shows a system 10 for preparing the recycling of lithium-ion batteries 22 in a schematic representation.

The system 10 comprises a shredding device 12 which is designed to mechanically shred objects, such as lithium-ion batteries 22, into fragments 26. For this purpose, the shredding device 12 comprises, in the present schematic representation, a container 14 and a shredding unit 16 arranged in the container 14.

The system 10 also includes a lithium sorption device 28. The lithium sorption device 28 comprises a container 18 which contains a sorbent 20. The sorbent 20 is designed to bind lithium ions. Preferably, the sorbent 20 is an aluminum oxide-based sorbent, a manganese oxide-based sorbent or a titanium oxide-based sorbent. The sorbent 20 is present as a solid. In the exemplary embodiment shown in FIG. 1, the container 18 is designed as a column.

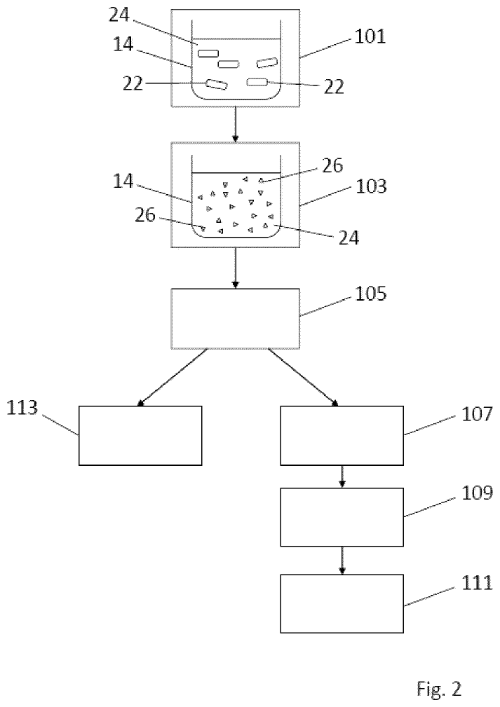

In the following, with additional reference to FIG. 2, an advantageous method for recovering lithium during the preparation of the recycling of lithium-ion batteries 22 is explained in more detail. FIG. 2 shows the method using a flow chart. The method is carried out by means of the system 10 shown in FIG. 1.

In a first step 101, a plurality of lithium-ion batteries 22 and a protective fluid 24 are provided and placed in the container 14 of the shredding device 12. The lithium-ion batteries 22 are then in contact with the protective fluid 24. The ratio of lithium-ion batteries 22 and protective fluid 24 is shown purely schematically in FIG. 2. In the present case, water is used as protective fluid 24.

In a second step 103, a shredding process is carried out, wherein the lithium-ion batteries 22 are mechanically shredded into fragments 26 in the presence of the protective fluid 24. The shredding process is carried out by the shredding unit 16, not shown in FIG. 2. The mechanical shredding prepares the lithium-ion batteries 22 for recycling. The representation of the fragments 26 is purely schematic with regard to their shape and size in FIG. 2. If the lithium-ion batteries 22 are charged or partially charged, there is a risk of fire during mechanical shredding. The shredding is therefore carried out in the presence of the protective fluid 24, which fulfills a fire protection function.

Because the protective fluid 24 is in contact with the lithium-ion batteries 22 during mechanical shredding, a portion of the substances contained in the lithium-ion batteries 22 are taken up by the protective fluid 24. In particular, lithium ions contained in the lithium-ion batteries 22 or the fragments 26 are partially washed out by the protective fluid 24.

If the lithium-ion batteries 22 are not completely discharged, but rather partially or fully charged, a discharging of the lithium-ion batteries 22 or the fragments 26 during the shredding process is achieved by the protective fluid 24. Heat energy arises from the discharging and is absorbed by the protective fluid 24. Preferably, the shredding process is carried out such that the protective fluid 24 is heated to a temperature of more than 80° C. A desired temperature of the protective fluid 24 can be achieved, for example, by selecting a suitable ratio of the number of lithium-ion batteries 22 to the volume of the protective fluid 24, or by using lithium-ion batteries 22 with a suitable average remaining charge.

In a third step 105, the fragments 26 and the protective fluid 24 are separated from each other. Preferably, the fragments 26 and the protective fluid 24 are separated from each other by filtration. Separation can be achieved, for example, by a separate filtration unit or by a filter that is integrated into a fluid outlet of the container 14. Alternatively, the fragments 26 and the protective fluid 24 can also be separated from each other by decanting.

In a fourth step 107, the protective fluid 24 is passed through the sorbent 20. Passing a fluid through a sorbent involves introducing the fluid into the sorbent and then draining the fluid from the sorbent. When the protective fluid 24 is passed through the sorbent 20, lithium ions contained in the protective fluid 24 are bound by the sorbent 20. Thus, a sorbent 20 enriched with lithium ions is obtained. Depending on the sorbent, the binding of lithium ions is based on an adsorption process or an ion exchange. Preferably, the protective fluid 24 has a temperature of more than 80° C. when introduced into the sorbent 20. Such a high temperature leads to an effective binding of the lithium ions by the sorbent 20.

In an optional fifth step 109, the sorbent 20 is rinsed. For this purpose, a rinsing fluid 30 is passed through the sorbent 20 enriched with lithium ions. By passing the rinsing fluid 30 through the sorbent 20, residues of the protective fluid 24 together with the unbound foreign substances are displaced from the sorbent 20. Preferably, inert gas, in particular nitrogen, or water is used as the rinsing fluid 30.

In a sixth step 111, a desorption fluid 32 is passed through the sorbent 20 enriched with lithium ions. The bound lithium ions are desorbed by the desorption fluid 32 so that a regenerated sorbent 20 and a desorption fluid 32 enriched with lithium ions are obtained. Depending on the sorbent 20, a different desorption fluid 32 is used. If the sorbent 20 is an aluminum oxide-based sorbent, low-salt water is preferably used as the desorption fluid 32. However, if the sorbent 20 is a manganese oxide-based sorbent or a titanium oxide-based sorbent, an acidic desorption fluid 32 is preferably used as the desorption fluid 32.

In subsequent steps that are not shown, the desorption fluid 32 enriched with lithium ions is further purified so that a lithium compound of battery quality is ultimately obtained.

In a seventh step 113, lithium contained in the fragments 26 is recovered by a pyrometallurgical treatment and/or by a hydrometallurgical treatment of the fragments 26. This process is the actual recycling of the lithium-ion batteries 22.

What is claimed is:

1. A method for recovering lithium during the preparation of the recycling of lithium-ion batteries, comprising:
a. carrying out a shredding process, wherein at least one lithium-ion battery is mechanically shredded into fragments in the presence of a protective fluid, in particular water or an aqueous solution, that is in contact with the lithium-ion battery,
b. following the shredding process, passing the protective fluid through a sorbent, wherein lithium ions contained in the protective fluid are bound by the sorbent, and a sorbent enriched with lithium ions is obtained, and
c. passing a desorption fluid through the sorbent enriched with lithium ions, wherein lithium ions are desorbed from the sorbent by the desorption fluid, and a desorption fluid enriched with lithium ions is obtained.

2. The method according to claim 1, wherein the sorbent is an aluminum oxide-based sorbent.

3. The method according to claim 1, wherein the sorbent is a manganese oxide-based sorbent.

4. The method according to claim 1, wherein the sorbent is a titanium oxide-based sorbent.

5. The method according to claim 1, wherein the fragments and the protective fluid are separated from one another, in particular by filtering, before passing the protective fluid through the sorbent.

6. The method according to claim 1, wherein the protective fluid is passed through the sorbent without chemical pretreatment following the shredding process.

7. The method according to claim 1, wherein when introducing the protective fluid into the sorbent, a temperature of the protective fluid exceeds a threshold temperature of 40° C., preferably a threshold temperature of 50° C., preferably a threshold temperature of 70° C., particularly preferably a threshold temperature of 80° C.

8. The method according to claim 7, wherein the shredding process is carried out in such a way that the protective fluid is heated by the shredding process to a temperature exceeding the threshold temperature.

9. The method according to claim 1, wherein before passing the desorption fluid through the sorbent enriched with lithium ions, a rinsing fluid, in particular inert gas or water, is passed through the sorbent enriched with lithium ions.

10. The method according to claim 1, wherein lithium contained in the fragments is recovered by a pyrometallurgical treatment and/or by a hydrometallurgical treatment of the fragments.
